(19) United States
(12) Patent Application Publication
(10) Pub. No.: US 2024/0000089 A1
(43) Pub. Date: Jan. 4, 2024

(54) CONTINUOUS LACTOSE HYDROLYSIS IN MILK AND OTHER DAIRY PRODUCTS

(71) Applicant: fairlife, LLC, Chicago, IL (US)

(72) Inventors: Kamil Piotr DRAPALA, Chicago, IL (US); Shakeel UR REHMAN, Naperville, IL (US); Timothy Peter DOELMAN, Glencoe, IL (US)

(73) Assignee: fairlife, LLC, Chicago, IL (US)

(21) Appl. No.: 18/252,398

(22) PCT Filed: Nov. 8, 2021
(86) PCT No.: PCT/US2021/058420

§ 371 Date: May 10, 2023

Related U.S. Application Data
(60) Provisional application No. 63/112,688, filed on Nov. 12, 2020.

(51) Int. Cl. A23C 9/12; A23C 3/037

(52) U.S. Cl. CPC A23C 9/1206; A23C 3/037

(57) ABSTRACT

Methods for making a dairy composition containing less than 2000 ppm of lactose can include the steps of subjecting a mixture of a dairy product and a lactase enzyme to a peak temperature from 55 to 78° C. for 15 sec to 15 min to form the dairy composition containing less than 2000 ppm of lactose, and then heat treating the dairy composition to deactivate the enzyme and to sterilize the dairy composition. The amount of the lactase enzyme is from 0.01 to 5 wt. %, based on the amount of lactose in the dairy product.

### REFERENCE TO RELATED APPLICATION

This application is being filed on 8 Nov. 2021 as a PCT International patent application, and claims priority to U.S. Provisional Application Ser. No. 63/112,688, filed on 12 Nov. 2020, the disclosure of which is incorporated herein by reference in its entirety.

### BACKGROUND OF THE INVENTION

The present invention relates generally to the hydrolysis of lactose in milk and other dairy products to reduce the lactose content of the final dairy formulation.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Consistent with aspects of this invention, a first method for making a dairy composition containing less than 2000 ppm of lactose is disclosed herein, and the first method can comprise (a) subjecting a mixture of a dairy product and a lactase enzyme to a peak temperature in a range from about 55 to about 78° C. for a time period in a range from about 15 sec to about 15 min to form the dairy composition containing less than 2000 ppm of lactose, wherein the amount of the lactase enzyme is from about 0.01 to about 5 wt. %, based on the amount of lactose in the dairy product, and (b) heat treating the dairy composition to deactivate the enzyme and to sterilize the dairy composition.

A second method for making a dairy composition containing less than 2000 ppm of lactose also is disclosed herein, and the second method can comprise subjecting a mixture of a dairy product and a lactase enzyme to a peak temperature in a range from about 55 to about 78° C. to form the dairy composition containing less than 2000 ppm of lactose. For instance, the second method can be employed for a time period sufficient for traditional pasteurization, while also allowing the lactase enzyme to reduce the lactose content to below 2000 ppm.

Using the first or second method, and often for enzyme treatment durations of as little as 1-3 min and up to 5-10 min, dairy compositions having lactose contents of less than or equal to about 1000 ppm, less than or equal to about 500 ppm, less than or equal to about 200 ppm, less than or equal to about 100 ppm, or less than or equal to about 50 ppm, and so forth, can be produced as described herein.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURE

The following FIGURE forms part of the present specification and is included to further demonstrate certain aspects of the present invention. The invention may be better understood by reference to this FIGURE in combination with the detailed description and examples.

FIG. 1 presents a schematic flow diagram of a production process for a dairy composition, which utilizes in-line continuous hydrolysis of lactose.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the designs, compositions, processes, and/or methods described herein are contemplated with or without explicit description of the particular combination. Additionally, unless explicitly recited otherwise, any aspect and/or feature disclosed herein can be combined to describe inventive designs, compositions, processes, and/or methods consistent with the present invention.

In this disclosure, while compositions and processes are often described in terms of “comprising” various components or steps, the compositions and processes also can “consist essentially of” or “consist of” the various components or steps, unless stated otherwise. For example, a dairy product or a dairy composition consistent with aspects of the present invention can comprise; alternatively, can consist essentially of; or alternatively, can consist of; a fat-rich fraction, a UF retentate fraction, and a RO retentate fraction.

The terms “a,” “an.” and “the” are intended to include plural alternatives, e.g., at least one, unless otherwise specified. For instance, the disclosure of “an ingredient” and “a lactase enzyme” are meant to encompass one, or mixtures or combinations of more than one, ingredient and lactase enzyme, unless otherwise specified.

In the disclosed processes, the term “combining” encompasses the contacting of components in any order, in any manner, and for any length of time, unless otherwise specified. For example, the components can be combined by blending or mixing.

Although any methods and materials similar or equivalent to those described herein can be used in the practice or testing of the invention, the typical methods and materials are herein described.

Various numerical ranges are disclosed herein. When a range of any type is disclosed or claimed herein, the intent is to disclose or claim individually each possible number that such a range could reasonably encompass, including end points of the range as well as any sub-ranges and combinations of sub-ranges encompassed therein, unless otherwise specified. As a representative example, the present application discloses that a dairy product or a dairy composition can have, in certain embodiments, from about 1 to about 15 wt. % protein. By a disclosure that the protein content can be in a range from about 1 to about 15 wt. %, the intent is to recite that the protein content can be any amount within the range and, for example, can be equal to about 1, about 2, about 3, about 4, about 5, about 6, about 7, about 8, about 9, about 10, about 11, about 12, about 13, about 14, or about 15 wt. %. Additionally, the dairy product or the dairy composition can contain an amount of protein within any range from about 1 to about 15 wt. % (for example, from about 2 to about 8 wt. %), and this also includes any combination of ranges between about 1 and about 15 wt. %. Further, in all instances, where “about” a particular value is disclosed, then that value itself is disclosed. Thus, the disclosure of a protein content from about 1 to about 15 wt. % also discloses a protein content from 1 to 15 wt. % (for example, from 2 to 8 wt. %), and this also includes any combination of ranges between 1 and 15 wt. %. Likewise, all other ranges disclosed herein should be interpreted in a manner similar to this example.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities. The term “about” can mean within 10% of the reported numerical value, preferably within 5% of the reported numerical value.

### DETAILED DESCRIPTION OF THE INVENTION

Lactose is the principal carbohydrate in milk and the majority of the humans become lactose intolerant after weaning due to a decrease or cessation of lactase enzyme (β-galactosidase) production in human intestines. Lactase enzyme converts lactose into glucose and galactose in the intestinal track to be absorbed in human body for energy. Milk and milk-based products are consumed by almost all humans even after weaning because of their nutritional benefits. However, lactose intolerant populations either stop consuming milk products that contain lactose or switch to alternative foods and beverages that do not contain lactose. Milk alternatives often do not provide the same nutrition as milk and therefore can put lactose intolerant population at a nutritional disadvantage.

In order to make lactose intolerant populations enjoy the benefits of consuming nutritional milk and milk-based products, the dairy industry provides lactose-free milk and milk products by converting lactose to simple absorbable sugars, glucose and galactose. The process of converting lactose into glucose and galactose by lactase enzyme treatment is known as lactose hydrolysis. Different techniques are used in dairy industry to perform lactose hydrolysis on an industrial scale. The enzyme can be in a soluble form or an immobilized form, with the former normally used for batch processes. The immobilized form can used in a continuous process, but is often used in batch processes to permit reactor cleaning and to prevent microbial growth.

Typically, lactose hydrolysis can be performed before packaging or after packaging. Prior to packaging, bulk milk is pasteurized and cooled and then transferred to big tanks where lactose hydrolysis occurs, often at 4-6° C. to prevent microbial growth. Depending upon the concentration of lactase enzyme, lactose hydrolysis may take 24-48 hr. Alternatively, hydrolysis can be carried out at 35° C. in 2-3 hr using high concentrations of enzyme, but some regulations do not allow holding drinking milk at 35° C. for 2-3 hr because this temperature is optimum for microbial growth and for activity of naturally occurring enzymes of milk, which deteriorates the taste of product. The lactose hydrolyzed milks are usually ultra-pasteurized to inactivate the lactase enzyme for retail distribution. High quality fresh raw milk with low microbial load can be subjected to lactose hydrolysis at 4-6° C. for 24 hr prior to normal pasteurization. The batchwise method does not need additional equipment, but the processes are time consuming and require energy to maintain the low temperatures during incubation time.

Lactose hydrolysis also can occur in retail packages. Pre-sterilized soluble lactase enzyme solution is injected aseptically as a continuous process before packaging and the lactose hydrolysis step occurs in the final containers. The enzyme solution can also be filter sterilized on-site as a part of the process and the filter sterilized enzyme is injected continuously as the packaging process proceeds. This process eliminates the use of bulk tanks for hydrolysis and reduces processing/enzyme costs. However, this process requires an enzyme with high purity (no protease or other side activities). Further, while some lactose hydrolysis can occur during transportation of the product, the product in the final container must be held until the lactose is completely hydrolyzed, and there can be variation in the taste of the product during its shelf-life due to presence of active enzyme. A key disadvantage is if the enzyme fails, then both the dairy product along with the expensive packaging must be discarded.

Another method to hydrolyze milk continuously is the use of an immobilized form of lactase enzyme. Development of an immobilized reactor for continuous hydrolysis of lactose in milk has been difficult. The difficulties to overcome include the neutral pH of milk, which encourages microbial growth in the reactor except at low temperatures or at very high temperatures. Milk proteins also tend to adsorb on immobilization surfaces and foul the reactor. Immobilization systems need special equipment and skills.

An objective of the present invention is to overcome the above disadvantages of lactose hydrolysis. The processes disclosed herein can be practiced continuously, and can be integrated as part of regular pasteurization, ultra-pasteurization or sterilization process, and beneficially, without specialized equipment. Herein, pre-sterilized enzyme solutions and aseptic dosing equipment are not required. Yet, the lactose hydrolysis time is reduced from 24 hr to 3-5 min. The time-temperature combination for lactose hydrolysis can occur in a pre-heat step for conventional ultra-pasteurization or sterilization treatment.

The rate (speed) of an enzymatic reaction depends on the environmental conditions like pH, temperature, concentration of the lactose, concentration of the enzyme, and catalytic inhibitors, among other factors. Generally, higher enzyme concentrations will provide faster hydrolysis rates, however, it will also lead to increased material costs. Increasing the incubation temperature will increase the speed of hydrolysis, unless the temperature exceeds the optimum temperature of the enzyme (often less than 40-60° C.), above which the enzyme starts to denature and loses its activity. Further, hydrolysis at elevated temperatures of 10-40° C. in dairy processing is typically avoided due to microbial concerns; however, enzyme activities are generally too low at temperatures below 10° C.

As noted above, commercial lactose hydrolysis processes can be divided into two general approaches: hydrolysis of the raw dairy product prior to thermal processing (pre-dosing) and hydrolysis of the finished product (post-dosing). The latter can significantly reduce enzyme consumption, resulting in lower material costs, but it requires an effective aseptic dosing system to allow sterile introduction of the enzyme to the product after its thermal treatment. It also requires a high purity of the enzyme in order to prevent it from interacting with other components of the product, since the enzyme remains active through the shelf-life (e.g., proteolytic, lipolytic, invertase or arylsulfatase activities must be completely absent).

In pre-dosing hydrolysis, dairy streams are hydrolyzed for between 4 and 24 hr (and often longer) at refrigeration conditions prior to their use in making desired dairy formulations. Having large quantities of several dairy streams that must to spend up to (and frequently in excess of) 24 hr prior to their availability for processing presents multiple challenges in manufacturing operations and diminishes production efficiency.

Another object of the present invention is to overcome the disadvantages of typical pre-dosing hydrolysis and post-dosing hydrolysis. A lactase enzyme (e.g., a beta-galactosidase enzyme, a product of bacterial fermentation, with a higher temperature of peak activity) is added to the product formulation during batching and the hydrolysis starts to take place during batching and is completed (i.e., the lactose is substantially hydrolyzed or completely hydrolyzed) during an additional pre-heating stage. This additional preheating stage operates at a minimum temperature of 55° C. and a maximum temperature of 78° C. (e.g., 63-70° C.), which concurrently prevents growth of spoilage microorganisms in the dairy formulations and prevents inactivation of the enzyme at higher temperatures.

Hydrolysis at this elevated temperature accelerates the rate of the lactose hydrolysis reaction, resulting in less time required to reduce the lactose content to the desired ppm content. Generally, if dairy products are exposed to temperatures in excess of refrigeration conditions (e.g., 7-10° C.) and below temperatures at which spoilage microorganisms are killed (e.g., less than 63-65° C. for 15-30 min), the product is not considered pasteurized and may not be suitable for sale. Herein, a mixture of a dairy product and a lactase enzyme passes through a pre-heating section on its way to a final heat treating step (e.g., UHT sterilization or pasteurization). Accelerated lactose hydrolysis of the mixture occurs generally at temperatures of 55-78° C. (or 63-70° C.), after which the mixture is exposed to a higher temperature (e.g., >80° C.) to deactivate residual lactase enzyme (thus, no active enzyme present that might negatively interact with the final dairy product), and then finally subjected to UHT sterilization or other suitable pasteurization technique.

In accordance with an aspect of this invention, a first method for making a dairy composition—containing less than 2000 ppm of lactose—can comprise (or consist essentially of, or consist of) (a) subjecting a mixture of a dairy product and a lactase enzyme to a peak temperature in a range from about 55 to about 78° C. for a time period in a range from about 15 sec to about 15 min to form the dairy composition containing less than 2000 ppm of lactose, wherein the amount of the lactase enzyme is from about 0.01 to about 5 wt. %, based on the amount of lactose in the dairy product, and (b) heat treating the dairy composition to deactivate the enzyme and to sterilize the dairy composition. In accordance with another aspect of this invention, a second method for making a dairy composition—containing less than 2000 ppm of lactose—can comprise (or consist essentially of, or consist of) subjecting a mixture of a dairy product and a lactase enzyme to a peak temperature in a range from about 55 to about 78° C. to form the dairy composition containing less than 2000 ppm of lactose. Optionally, the second method can be employed for a time period sufficient for traditional pasteurization, while also allowing the lactase enzyme to reduce the lactose content to below 2000 ppm.

Generally, the features of these first and second methods (e.g., the characteristics of the dairy product, the characteristics of the dairy composition, the lactase enzyme, the peak temperature, the heat treatment, and the residual lactose content, among others) are independently described herein and these features can be combined in any combination to further describe the disclosed methods. Moreover, other process steps can be conducted before, during, and/or after any of the steps listed in the disclosed methods, unless stated otherwise. Additionally, any dairy compositions (e.g., finished milk products, ready for consumption) produced in accordance with any of the disclosed methods are within the scope of this disclosure and are encompassed herein.

Referring to step (b) of the first process, the dairy composition can be heat treated to deactivate the enzyme and to sterilize the dairy composition. In one aspect, the step of heat treating can comprise pasteurizing at a temperature in a range from about 80° C. to about 95° C. for a time period in a range from about 2 to about 15 min. In another aspect, the step of heat treating can comprise UHT sterilization at a temperature in a range from about 135° C. to about 145° C. for a time period in a range from about 1 to about 10 sec. In yet another aspect, the step of heat treating can comprise UHT sterilization at a temperature in a range from about 148° C. to about 165° C. for a time period in a range from 0 to about 1 sec (e.g., about 0.05 to about 1 sec, about 0.05 to about 0.5 sec). Other appropriate pasteurization or sterilization temperature and time conditions are readily apparent from this disclosure. Further, this invention is not limited by the method or equipment used for performing the pasteurization/sterilization process—any suitable technique and apparatus can be employed, whether operated batchwise or continuously.

For instance, typical UHT sterilization techniques include indirect steam heating, direct steam injection, direct steam infusion, and the like. For indirect steam heating, the dairy composition is not contacted directly with the heat source or heating medium, e.g., like a heat exchanger. Due to the heat transfer limitations, indirect heating requires a longer time for sterilization. Beneficially, in aspects of this invention, the dairy composition is heat treated using direct UHT sterilization. In direct steam injection, high temperature steam is injected into the pipe or other vessel containing the dairy composition, thus rapidly sterilizing the dairy composition. Direct steam injection generally is performed continuously—a continuous flow of the dairy composition is combined with a continuous injection of steam. In direct steam infusion, the dairy composition is sprayed into a chamber containing steam, thus rapidly and uniformly sterilizing the dairy composition. Like direct steam injection, direct steam infusion generally is performed continuously. After the heat treatment step, the dairy composition can be cooled to any suitable temperature, such as in a range from about 5° C. to about 40° C., or from about 10° C. to about 30° C.

Referring now to both the first method and the second method for making a dairy composition (which contains less than 2000 ppm of lactose), the dairy product and/or the dairy composition can be whole milk, low-fat milk, skim milk, buttermilk, flavored milk, low lactose milk, high protein milk, lactose-free milk, ultra-filtered milk, micro-filtered milk, concentrated milk, evaporated milk, or high protein, high calcium, and reduced sugar milk, and the like.

In some aspects, the dairy product and/or the dairy composition can comprise a UF permeate fraction, a UF retentate fraction, a NF permeate fraction, a NF retentate fraction, a RO permeate fraction, a RO retentate fraction, a fat-rich fraction, and the like, as well as any combination thereof. These milk fractions can be produced by various known filtration technologies and processes, non-limiting examples of which are disclosed in U.S. Pat. Nos. 7,169,428, 9,510,606, and 9,538,770, which are incorporated herein by reference in their entirety. Such technologies (e.g., ultrafiltration, nanofiltration, and reverse osmosis) can separate or concentrate components in mixtures—such as milk—by passing the mixture through a membrane system (or selective barrier) under a suitable conditions (e.g., pressure). The concentration/separation can be, therefore, based on molecular size. The stream that is retained by the membrane is called the retentate (or concentrate). The stream that passes through the pores of the membrane is called the permeate.

Ultrafiltering can be conducted using ultrafiltration membranes with pore sizes that typically are in the 0.01 to 0.1 micron range. In the dairy industry, the ultrafiltration membranes often are identified based on molecular weight cut-off (MWCO), rather than pore size. The molecular weight cut-off for ultrafiltration membranes can vary from 1,000-100,000 Daltons. For instance, the milk product can be ultrafiltered using a polymeric membrane system (ceramic membranes also can be employed). The polymeric membrane system can be configured with pore sizes such that the materials having molecular weights greater than about 1,000 Daltons, greater than about 5,000 Daltons, or greater than about 10,000 Daltons, are retained, while lower molecular weight species pass through. In some aspects, the step of ultrafiltering utilizes a membrane system having pore sizes in a range from about 0.01 to about 0.1 μm, and operating pressures typically in the 45-150 psig range.

Nanofiltration in the dairy industry typically uses membrane elements that retain particles with molecular weights above approximately 100-300 Da. Nanofiltration is a pressure driven process in which the liquid is forced through a membrane under pressure, and materials having a molecular weight greater than the specified cut-off are retained, while smaller particles pass though the membrane pores. For generally separating lactose from minerals in an incoming stream, a pore size can be selected for maximum retention of lactose. Like ultrafiltration, nanofiltration can simultaneously perform both concentration and separation. Nanofiltering can be conducted using nanofiltration membranes with pore sizes that typically are in the 0.001 to 0.01 micron range, for example, pore sizes in a range from about 0.001 to about 0.008 μm. In some embodiments, the step of nanofiltration utilizes a membrane system having pore sizes in a range from 0.001 to about 0.01 μm, with operating pressures typically in the 150-450 psig range, and operating temperatures ranging from about 10 to about 60° C. (or from about 15 to about 45° C.), although not limited thereto.

Reverse osmosis is a fine filtration process or concentration process in which substantially all the remaining milk components are retained (RO retentate), and only water (RO permeate, milk water) passes through. Often, reverse osmosis membrane systems have a molecular weight cutoff of much less than 100 Da and, therefore, components other than water are concentrated in the reverse osmosis process (e.g., minerals). Generally, reverse osmosis comprises a membrane system having pore sizes of less than or equal to about 0.001 sm. Operating pressures typically are in the 450-1500 psig, or 450-600 psig, range. Temperatures ranging from about 5 to about 45° C., or from about 15 to about 45° C., often can used.

While not being limited thereto, the protein content of the dairy product and/or the dairy composition often can be at least about 1 wt. % or 2 wt. % protein, and generally up to about 10 wt. % or about 15 wt. % protein. Illustrative and non-limiting ranges for the protein content of the dairy product and/or the dairy composition can include from about 1 to about 15 wt. %, from about 3 to about 10 wt. %, from about 2 to about 8 wt. %, or from about 3 to about 6 wt. %.

Likewise, the fat content and mineral content and solids content of the dairy product and/or the dairy composition are not particularly limited. Typical ranges for the fat content of the dairy product and/or the dairy composition include from about 0.05 to about 10 wt. % fat, or from about 0.1 to about 5 wt. % fat, while typical ranges for the mineral content of the dairy product and/or the dairy composition include from about 0.5 to about 2 wt. %, from about 0.5 to about 1.5 wt. %, or from about 0.5 to about 1 wt. %. Typical ranges for the solids content of the dairy product and/or the dairy composition include from about 5 to about 50 wt. % solids, from about 6 to about 35 wt. % solids, or from about 8 to about 16 wt. % solids.

In the first method and the second method, a mixture of a dairy product and a lactase enzyme is subjected to a peak temperature in a range from about 55 to about 78° C. to form the dairy composition containing less than 2000 ppm of lactose. The initial lactose content of the dairy product—prior to enzymatic treatment—is not particularly limited, with a typical minimum lactose content of around 0.5 wt. % lactose and a maximum lactose content of around 20 wt. %. Thus, the lactose content of the dairy product can be from about 0.5 to about 10 wt. % in one aspect, while in another aspect, the lactose content can be from about 1 to about 6 wt. %, and in yet another aspect, the lactose content can be from about 0.5 to about 5 wt. %.

After enzymatic treatment and lactose hydrolysis (to glucose/galactose), the residual lactose content in the dairy composition is less than 2000 ppm (by weight), such as less than or equal to about 1000 ppm; alternatively, less than or equal to about 500 ppm; alternatively, less than or equal to about 200 ppm; alternatively, less than or equal to about 100 ppm; or alternatively, less than or equal to about 50 ppm. The minimum amount of lactose is generally not determined, so long as the lactose content of the dairy composition does not exceed a particular maximum value. Nonetheless, the minimum amount of lactose often can be an amount greater than zero, such as at least 1 ppm (by weight), at least 5 ppm, at least 10 ppm, or at least 25 ppm.

With these respective lactose contents of the dairy product and the dairy composition, the dairy product and/or the dairy composition in one aspect can contain less than or equal to about 0.5 wt. % fat, from about 2 to about 15 wt. % protein, and from about 0.5 to about 2 wt. % minerals. In another aspect, the dairy product and/or the dairy composition can contain from about 0.5 to about 1.5 wt. % fat, from about 2 to about 15 wt. % protein, and from about 0.5 to about 2 wt. % minerals. In yet another aspect, the dairy product and/or the dairy composition can contain from about 1.5 to about 2.5 wt. % fat, from about 2 to about 15 wt. % protein, and from about 0.5 to about 2 wt. % minerals. In still another aspect, the dairy product and/or the dairy composition can contain from about 2.5 to about 5 wt. % fat, from about 2 to about 15 wt. % protein, and from about 0.5 to about 2 wt. % minerals.

Herein, the dairy product and/or the dairy composition can further contain an ingredient, non-limiting examples of which can include a sugar/sweetener, a flavorant, a preservative, a stabilizer, an emulsifier, a prebiotic substance, a probiotic bacteria, a vitamin, a mineral, an omega 3 fatty acid, a phyto-sterol, an antioxidant, a colorant, and the like, as well as any mixture or combination thereof. For instance, one or more of these ingredients can be added to the mixture of the dairy product and the lactase enzyme prior to exposure at the peak temperature in the −55-78° C. range.

Beneficially, the dairy product and the lactase enzyme can be combined batchwise or continuously, and in any suitable vessel (e.g., a tank, a silo, etc.), optionally with agitation or mixing.

The first and second methods to produce the dairy composition can be conducted at any suitable temperature and for any suitable period of time. Representative and non-limiting ranges for the peak temperature that the mixture of the dairy product and the lactase enzyme is subjected to can include from about 60 to about 77° C.; alternatively, from about 62 to about 77° C.; alternatively, from about 62 to about 72° C.; alternatively, from about 63 to about 75° C.; alternatively, from about 63 to about 70° C.; or alternatively, from about 65 to about 70° C. These temperature ranges also are meant to encompass circumstances where the second process or step (a) of the first process (or the formation of the dairy composition) is performed at a series of different temperatures, instead of at a single fixed temperature, falling within the respective temperature ranges, wherein at least one temperature is within the recited ranges.

Similarly, the time period or duration of subjecting the mixture to the peak temperature is not particularly limited, and can be conducted for any suitable period of time. In some aspects, the time period can be least about 15 sec, at least about 1 min, at least about 2 min, or at least about 3 min, and up to about 10 min, 15 min. 20 min, or 30 min. For instance, the time period can be from about 15 sec to about 15 min, from about 30 sec to about 10 min, from about 30 min to about 8 min, from about 1 min to about 10 min, from about 1 min to about 5 min, or from about 3 min to about 6 min.

Herein, the lactase enzyme is a lactase enzyme having a higher temperature of peak activity than traditional lactase enzymes, and often the temperature of peak activity of the lactase enzyme used herein is in the −55-78° C. range. A suitable lactase enzyme for use herein is a beta-galactosidase, although not limited thereto. Advantageously, the lactase enzyme used herein often is stable at the peak temperature, is not deactivated at the peak temperature, or is both stable at the peak temperature and not deactivated at the peak temperature. Generally, although not required, the lactase enzyme is deactivated when exposed to temperatures of 80° C. and above.

The amount of the lactase enzyme that is combined with the dairy product in the mixture can depend upon a number factors, including the amount of lactose in the dairy product, the desired level of residual lactose in the dairy composition, the peak temperature, and the duration of enzymatic treatment, amongst others. Nonetheless, the amount of the lactase enzyme based on the total weight of the mixture of the dairy product and the lactase enzyme can fall within a range from about 2 to about 1000 ppm (by weight), such as from about 5 to about 500 ppm, from about 2 to about 200 ppm, or from about 3 to about 150 ppm. Stated another way, the amount of the lactase enzyme based on the amount of lactose in the dairy product often can fall within a range from about 0.01 to about 5 wt. %, such as from about 0.025 to about 5 wt. %, from about 0.01 to about 2 wt. %, from about 0.025 to about 2 wt. %, from about 0.01 to about 1 wt. %, or from about 0.025 to about 1 wt. %, although not limited thereto.

In some aspects of this invention, the first and second methods for making a dairy composition can further comprise a step of packaging (aseptically or otherwise) the dairy composition in any suitable container and under any suitable conditions. Any suitable container can be used, such as might be used for the distribution and/or sale of dairy items in a retail outlet. Illustrative and non-limiting examples of typical containers include a cup, a bottle, a bag, or a pouch, and the like. The container can be made from any suitable material, such as glass, metal, plastics, and the like, as well as combinations thereof.

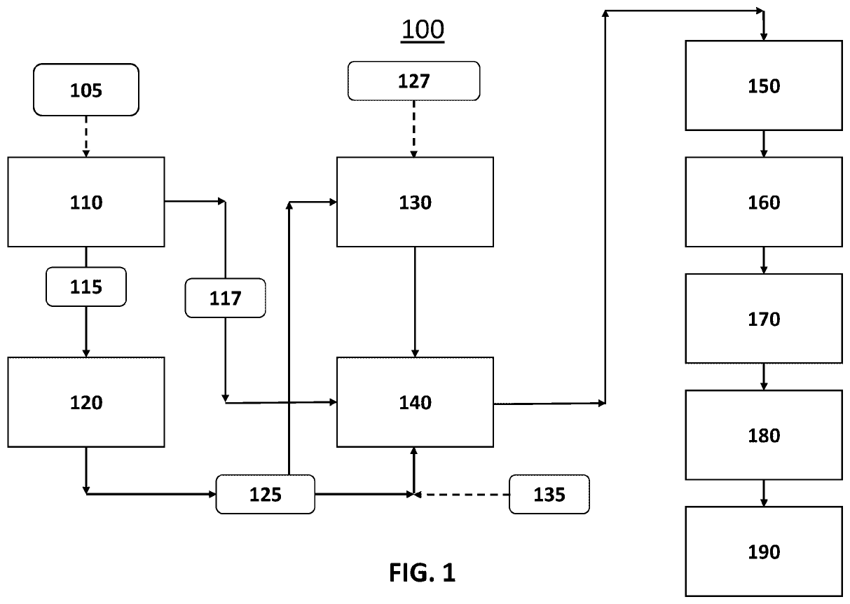

An illustrative and non-limiting example of a production process 100 for a dairy composition, which utilizes in-line continuous hydrolysis of lactose, consistent with aspects of this invention is shown in FIG. 1. Raw milk 105 is first subjected to centrifugal separation 110 to form skim milk 115 and cream 117 (or a fat-rich fraction). The skim milk 115 then is subjected to a membrane filtration process 120 (e.g., UF, NF, RO, and the like, in any combination) to form various filtration streams 125 (e.g., UF retentate, RO retentate, and the like). The filtration streams 125 can be combined in any suitable proportions with other ingredients 127 and mixed 130 to form a dairy product, which can be stored in a vessel 140, often at from 2° C. to 5° C., prior to further processing.

FIG. 1 shows the lactase enzyme 135 combining with the filtration streams 125 (any individual filtration stream, or all filtration streams) before entering the vessel 140, but alternatively, the lactase enzyme 135 can be fed directly to the vessel 140 which houses the dairy product. Also alternatively, the dairy product exiting the vessel 140 can be mixed with lactase enzyme 135. Regardless of the method or manner in which the lactase enzyme is combined with the dairy product, the mixture of the dairy product and the lactase enzyme is subjected to a continuous heat treatment step 150, in which the mixture is heated rapidly (usually within 1 min, such as from 5 to 30 sec) from −2-5° C. to at least about 55° C. Then, in the continuous heat treatment step 150, the mixture of the dairy product and the lactase enzyme is maintained at a peak temperature of from 55 to 78° C. (e.g., 63-70° C.) for accelerated lactose hydrolysis over a time frame of 1-5 min, for example. Both the heat ramp and maintaining the mixture at the peak temperature can be accomplished by continuously flowing the mixture in a pipe within a heat exchanger or similar device, although other methods and devices can be used.

In an optional continuous protein stabilization step 160, the temperature of the mixture is increased to over 72-85° C.—for instance, 85° C.—to stabilize the protein and deactivate residual lactase enzyme, and this step can range from a few sec to 15-30 min or more, but generally occurs in less than 1 min. Afterwards, the temperature of dairy composition is rapidly increased (from 85° C. or less to −137-165° C.) during a continuous UHT sterilization step 170, which often can be accomplished in less than 5 sec, less than 2 sec. or less than 1 sec. Next, the dairy composition is homogenized/cooled 180, and filled or packaged 190 into suitable containers.

In sum, a first method for continuously making a dairy composition containing less than 2000 ppm of lactose can comprise (a) subjecting a mixture of a dairy product and a lactase enzyme to a peak temperature in a range from about 55 to about 78° C. for a time period in a range from about 15 sec to about 15 min to form the dairy composition containing less than 2000 ppm of lactose, wherein the amount of the lactase enzyme is from about 0.01 to about 5 wt. %, based on the amount of lactose in the dairy product, and (b) heat treating the dairy composition to deactivate the enzyme and to sterilize the dairy composition.

Another specific method provided herein for continuously making a dairy composition containing less than 2000 ppm of lactose (or less than or equal to about 1000 ppm of lactose, or less than or equal to about 500 ppm of lactose, or less than or equal to about 100 ppm of lactose) can comprise (a) subjecting a mixture of a dairy product (containing from about 0.5 to about 10 wt. %, or from about 1 to about 6 wt. %, or from about 0.5 to about 5 wt. %, of lactose) and a lactase enzyme to a peak temperature in a range from about 60 to about 77° C. (or from about 62 to about 72° C., or from about 63 to about 75° C., or from about 63 to about 70° C.) for a time period in a range from about 30 sec to about 10 min (or from about 1 min to about 10 min, or from about 1 min to about 5 min, or from about 3 min to about 6 min) to form the dairy composition containing less than 2000 ppm of lactose (or less than or equal to about 1000 ppm of lactose, or less than or equal to about 500 ppm of lactose, or less than or equal to about 100 ppm of lactose), wherein the amount of the lactase enzyme is from about 0.025 to about 5 wt. % (or from about 0.01 to about 2 wt. %, or from about 0.01 to about 1 wt. %, or from about 0.025 to about 1 wt. %), based on the amount of lactose in the dairy product, and (b) heat treating the dairy composition to deactivate the enzyme and to sterilize the dairy composition.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Total solids (wt. %) were determined in accordance with procedure SMEDP 15.10 C by CEM Turbo Solids and Moisture Analyzer (CEM Corporation, Matthews, North Carolina). Ash is the residue remaining after ignition in a suitable apparatus at 550° C. to a constant weight: such treatment at 550° C. typically eliminates all organic matter, with the remaining material being primarily minerals (Standard Methods for the examination of dairy products, 17^{th} edition (2004), American Public Health Association, Washington DC). The ash test can be performed using a Phoenix (CEM Microwave Furnace), which heats the samples at 550° C. for 30 min. The mineral content (in wt. %) is generally similar to the ash content (wt. %), and thus the result of an ash test is used for quantification of the total mineral content in this disclosure.

Lactose content, whether in wt. % or in ppm by weight, was determined using the LactoSens method. The LactoSens method is a biosensor assay kit intended for the determination of lactose levels in a variety of lactose-free or low-lactose milk and dairy products. An enzyme immobilized on a disposable test strip oxidizes the lactose in the test portion and the resulting electrons are detected amperometrically by the LactoSens Reader. Proprietary software converts the electrical signal into a lactose concentration according to the factory-set calibration function. Each test strip is labelled with a QR code for sample tracking and batch-specific information and a ready-to-use positive control is provided for quality assurance. The method is described in Halbmayr-Jech, E., Kittl, R., Weinmann, P., Schulz, C., Kowalik, A., Sygmund, C., & Brunelle, S. (2020); Determination of Lactose in Lactose-free and Low-lactose Milk. Milk Products, and Products Containing Dairy Ingredients by the LactoSens® R Amperometry Method: First Action 2020.01: Journal of AOAC International; the disclosure of which is incorporated herein by reference in its entirety.

### Examples 1-63

Table I summarizes the solids, protein, fat, mineral, and lactose contents of five dairy products that were used in Examples 1-63. The lactose contents (initial lactose contents) of these five dairy products were in the 1-4 wt. % range. Table II summarizes the dairy product used in Examples 1-63, the amount of the enzyme additive (in wt. %) mixed with the dairy product, the lactase enzyme addition amount (in ppm by weight) based on the weight of the dairy product, the lactase enzyme addition amount (in wt. %) based on the amount of lactose in the dairy product, the incubation time and temperature, and the residual lactose (in ppm by weight) remaining after treatment with the lactase enzyme. The enzyme additive contained between 1 and 5 wt. % of active lactase enzyme, therefore the respective ranges are shown in Table II for the lactase enzyme addition amount (in ppm by weight) based on the weight of the dairy product, and for the lactase enzyme addition amount (in wt. %) based on the amount of lactose in the dairy product. The lactase enzyme (β-galactosidase) used was a Neutral Bacterial Enzyme indirectly obtained from Lactobacillus bulgaricus, and this enzyme is active in a temperature range of approximately 50-70° C. The enzyme had an activity of 15250 SD lactase units/g or more.

Examples 1-63 were performed by mixing the dairy product in Table I with the listed enzyme additive amount for the respective incubation time and temperature, followed by quenching the mixture and analyzing the mixture for residual lactose content. The variables that affected the residual lactose content were the initial lactose content, enzyme addition amount, incubation time, incubation temperature, and type of dairy product (e.g., lactose in certain chocolate milks can take longer to hydrolyze).

For reduced fat milk 1 in Examples 1-16 at a constant temperature of 63° C., an enzyme addition amount of only 0.116 wt. % (11-58 ppm lactase based on the dairy product; 0.04-0.23 wt. % lactase based on the lactose in milk product 1) for 5-10 min was sufficient to reduce the lactose content to a range of 180-330 ppm lactose. For chocolate milk 1 in Examples 17-21 at the constant temperature of 63° C., higher levels of enzyme addition—from 0.06-0.34 wt. % up to 0.13-0.68 wt. % lactase—based on the lactose in chocolate milk 1 resulted in significant and surprising reductions in the lactose content (to a range of less than 80 ppm to 410 ppm) in only 1-5 min.

Examples 22-34 used chocolate milk 2 at a constant incubation time of 3 min and slightly higher temperatures of 64-71° C. Unexpectedly, given only 3 min of treatment at the noted temperature, all of the examples in which at least 0.1 wt. % of the enzyme additive was used (from 0.09-0.44 wt. % up to 0.17-0.85 wt. % lactase, based on the lactose in chocolate milk 2) produced dairy compositions containing less than 80 ppm residual lactose content.

Examples 35-58 used reduced fat milk 2 containing the highest level of lactose (3.12 wt. %) and was treated with the lactase enzyme at incubation times of 3-5 min and temperatures of 62-70° C. Due to the higher lactose content, higher addition amounts of the enzyme additive in the 0.2-0.3 wt. % range were used to reduce the residual lactose content to under 1000 ppm.

In sum, these examples demonstrate that high temperature treatment with relatively small amounts of a lactase enzyme having a higher temperature of peak activity can reduce residual lactose contents to less than 2000 ppm, and less than 80 ppm in some cases, in time durations as short as 1-5 min.

TABLE I

| | Total | | | | |
|---|---|---|---|---|---|
| | solids | Protein | Fat | Minerals | Lactose |
| Dairy Product | (wt. %) | (wt. %) | (wt. %) | (wt. %) | (wt. %) |
| Reduced Fat Milk 1 | 10.56 | 5.35 | 1.90 | 0.77 | 2.54 |
| Chocolate Milk 1 | 13.89 | 10.31 | 0.79 | 0.95 | 1.72 |
| Chocolate Milk 2 | 10.22 | 6.09 | 1.02 | 1.03 | 1.15 |
| Reduced Fat Milk 2 | 9.64 | 3.80 | 1.95 | 0.74 | 3.12 |
| Chocolate Milk 3 | 12.42 | 3.73 | 1.95 | 0.81 | 2.37 |

TABLE II

| | | Enzyme | | | Incubation | Incubation | Residual |
|---|---|---|---|---|---|---|---|
| | | Additive | Lactase | Lactase/lactose | time | Temperature | lactose |
| Example | Dairy Product | (wt. %) | (ppm) | (wt. %) | (min) | (° C.) | (ppm) |
| 1 | Reduced Fat Milk 1 | 0.058 | 5-29 | 0.02-0.11 | 3 | 63 | >2000 |
| 2 | Reduced Fat Milk 1 | 0.116 | 11-58 | 0.04-0.23 | 3 | 63 | 1660 |
| 3 | Reduced Fat Milk 1 | 0.116 | 11-58 | 0.04-0.23 | 5 | 63 | 330 |
| 4 | Reduced Fat Milk 1 | 0.058 | 5-29 | 0.02-0.11 | 10 | 63 | 880 |
| 5 | Reduced Fat Milk 1 | 0.116 | 11-58 | 0.04-0.23 | 7 | 63 | 180 |
| 6 | Reduced Fat Milk 1 | 0.087 | 8-43 | 0.03-0.17 | 10 | 63 | 210 |
| 7 | Reduced Fat Milk 1 | 0.116 | 11-58 | 0.04-0.23 | 10 | 63 | 240 |
| 8 | Reduced Fat Milk 1 | 0.116 | 11-58 | 0.04-0.23 | 10 | 63 | 180 |
| 9 | Reduced Fat Milk 1 | 0.058 | 5-29 | 0.02-0.11 | 3 | 63 | >2000 |
| 10 | Reduced Fat Milk 1 | 0.058 | 5-29 | 0.02-0.11 | 10 | 63 | 880 |
| 11 | Reduced Fat Milk 1 | 0.087 | 8-43 | 0.03-0.17 | 10 | 63 | 210 |
| 12 | Reduced Fat Milk 1 | 0.116 | 11-58 | 0.04-0.23 | 3 | 63 | 1660 |
| 13 | Reduced Fat Milk 1 | 0.116 | 11-58 | 0.04-0.23 | 5 | 63 | 330 |
| 14 | Reduced Fat Milk 1 | 0.116 | 11-58 | 0.04-0.23 | 7 | 63 | 180 |
| 15 | Reduced Fat Milk 1 | 0.116 | 11-58 | 0.04-0.23 | 10 | 63 | 240 |
| 16 | Reduced Fat Milk 1 | 0.116 | 11-58 | 0.04-0.23 | 10 | 63 | 180 |
| 17 | Chocolate Milk 1 | 0.117 | 11-59 | 0.06-0.34 | 3 | 63 | 410 |
| 18 | Chocolate Milk 1 | 0.156 | 15-78 | 0.09-0.45 | 3 | 63 | 100 |
| 19 | Chocolate Milk 1 | 0.156 | 15-78 | 0.09-0.45 | 5 | 63 | <80 |
| 20 | Chocolate Milk 1 | 0.234 | 23-117 | 0.13-0.68 | 1 | 63 | 180 |
| 21 | Chocolate Milk 1 | 0.234 | 23-117 | 0.13-0.68 | 3 | 63 | <80 |
| 22 | Chocolate Milk 2 | — | — | — | N/A | N/A | >2000 |
| 23 | Chocolate Milk 2 | 0.156 | 15-78 | 0.13-0.68 | 3 | 65 | <80 |
| 24 | Chocolate Milk 2 | 0.195 | 19-98 | 0.17-0.85 | 3 | 65 | <80 |
| 25 | Chocolate Milk 2 | 0.117 | 11-59 | 0.10-0.51 | 3 | 65 | <80 |
| 26 | Chocolate Milk 2 | 0.117 | 11-59 | 0.10-0.51 | 3 | 70 | <80 |
| 27 | Chocolate Milk 2 | 0.078 | 7-39 | 0.07-0.34 | 3 | 70 | 300 |
| 28 | Chocolate Milk 2 | 0.101 | 10-50 | 0.09-0.44 | 3 | 70 | <80 |
| 29 | Chocolate Milk 2 | 0.117 | 11-59 | 0.10-0.51 | 3 | 70.6-64.0 | <80 |
| 30 | Chocolate Milk 2 | 0.117 | 11-59 | 0.10-0.51 | 3 | 70.6-64.0 | <80 |
| 31 | Chocolate Milk 2 | 0.117 | 11-59 | 0.10-0.51 | 3 | 70.6-64.0 | <80 |
| 32 | Chocolate Milk 2 | 0.117 | 11-59 | 0.10-0.51 | 3 | 70.6-64.0 | <80 |
| 33 | Chocolate Milk 2 | 0.117 | 11-59 | 0.10-0.51 | 3 | 70.6-64.0 | <80 |
| 34 | Chocolate Milk 2 | 0.117 | 11-59 | 0.10-0.51 | 3 | 70.6-64.0 | <80 |
| 35 | Reduced Fat Milk 2 | 0.111 | 11-55 | 0.03-0.18 | 3 | 70 | 1500 |
| 36 | Reduced Fat Milk 2 | 0.148 | 15-74 | 0.05-0.24 | 3 | 70 | 1460 |
| 37 | Reduced Fat Milk 2 | 0.185 | 18-92 | 0.06-0.30 | 3 | 70 | >2000 |
| 38 | Reduced Fat Milk 2 | 0.111 | 11-55 | 0.03-0.18 | 5 | 70 | 1250 |
| 39 | Reduced Fat Milk 2 | 0.185 | 18-92 | 0.06-0.30 | 5 | 70 | 530 |
| 40 | Reduced Fat Milk 2 | 0.222 | 22-111 | 0.07-0.36 | 3 | 70 | 610 |
| 41 | Reduced Fat Milk 2 | 0.259 | 26-129 | 0.08-0.42 | 3 | 70 | 790 |
| 42 | Reduced Fat Milk 2 | 0.222 | 22-111 | 0.07-0.36 | 5 | 70 | 340 |
| 43 | Reduced Fat Milk 2 | 0.296 | 30-148 | 0.09-0.47 | 3 | 70 | 570 |
| 44 | Reduced Fat Milk 2 | 0.296 | 30-148 | 0.09-0.47 | 5 | 70 | 890 |
| 45 | Reduced Fat Milk 2 | 0.222 | 22-111 | 0.07-0.36 | 3 | 65 | <80 |
| 46 | Reduced Fat Milk 2 | 0.222 | 22-111 | 0.07-0.36 | 3 | 69.9-62.8 | >2000 |
| 47 | Reduced Fat Milk 2 | 0.222 | 22-111 | 0.07-0.36 | 3 | 69.9-62.8 | >2000 |
| 48 | Reduced Fat Milk 2 | 0.222 | 22-111 | 0.07-0.36 | 3 | 69.9-62.8 | >2000 |
| 49 | Reduced Fat Milk 2 | 0.296 | 30-148 | 0.09-0.47 | 3 | 68.2-63.2 | 570 |
| 50 | Reduced Fat Milk 2 | 0.296 | 30-148 | 0.09-0.47 | 3 | 68.2-63.2 | 520 |
| 51 | Reduced Fat Milk 2 | 0.296 | 30-148 | 0.09-0.47 | 3 | 68.2-63.2 | 480 |
| 52 | Reduced Fat Milk 2 | 0.296 | 30-148 | 0.09-0.47 | 5 | 69.6-63.7 | — |
| 53 | Reduced Fat Milk 2 | 0.296 | 30-148 | 0.09-0.47 | 5 | 69.6-63.7 | — |
| 54 | Reduced Fat Milk 2 | 0.296 | 30-148 | 0.09-0.47 | 5 | 69.6-63.7 | 540 |
| 55 | Reduced Fat Milk 2 | 0.296 | 30-148 | 0.09-0.47 | 5 | 69.6-63.7 | 650 |
| 56 | Reduced Fat Milk 2 | 0.296 | 30-148 | 0.09-0.47 | 5 | 68.1-64.3 | — |
| 57 | Reduced Fat Milk 2 | 0.296 | 30-148 | 0.09-0.47 | 5 | 68.1-64.3 | — |
| 58 | Reduced Fat Milk 2 | 0.296 | 30-148 | 0.09-0.47 | 5 | 68.1-64.3 | 260 |
| 59 | Chocolate Milk 3 | 0.296 | 30-148 | 0.12-0.62 | 5 | 68.1-64.3 | 270 |
| 60 | Chocolate Milk 2 | 0.078 | 7-39 | 0.07-0.34 | 5 | 67.6-64.0 | — |
| 61 | Chocolate Milk 2 | 0.078 | 7-39 | 0.07-0.34 | 5 | 67.6-64.0 | — |
| 62 | Chocolate Milk 2 | 0.078 | 7-39 | 0.07-0.34 | 5 | 67.6-64.0 | 1250 |
| 63 | Chocolate Milk 2 | 0.078 | 7-39 | 0.07-0.34 | 5 | 67.6-64.0 | 980 |

1. A method for making a dairy composition containing less than 2000 ppm of lactose, the method comprising:
(a) subjecting a mixture of a dairy product and a lactase enzyme to a peak temperature in a range from about 55 to about 78° C. for a time period in a range from about 15 sec to about 15 min to form the dairy composition containing less than 2000 ppm of lactose; wherein an amount of the lactase enzyme is from about 0.01 to about 5 wt. %, based on an amount of lactose in the dairy product; and
(b) heat treating the dairy composition to deactivate the enzyme and to sterilize the dairy composition.

2. The method of claim 1, wherein the peak temperature is in a range:
from about 60 to about 77° C.;
from about 62 to about 72° C.;
from about 63 to about 75° C.;
from about 63 to about 70° C.; or
from about 65 to about 70° C.

3. The method of claim 1, wherein the time period is in a range:
from about 30 sec to about 10 min;
from about 30 min to about 8 min;
from about 1 min to about 10 min;
from about 1 min to about 5 min; or
from about 3 min to about 6 min.

4. The method of claim 1, wherein the dairy product has:
a lactose content of from about 0.5 to about 10 wt. %;
a lactose content of from about 1 to about 6 wt. %; or
a lactose content of from about 0.5 to about 5 wt. %.

5. The method of claim 1, wherein the dairy composition has:
a lactose content of less than or equal to about 1000 ppm;
a lactose content of less than or equal to about 500 ppm;
a lactose content of less than or equal to about 200 ppm;
a lactose content of less than or equal to about 100 ppm; or
a lactose content of less than or equal to about 50 ppm.

6. The method of claim 1, wherein the amount of the lactase enzyme based on the amount of lactose in the dairy product is:
from about 0.025 to about 5 wt. %;
from about 0.01 to about 2 wt. %;
from about 0.025 to about 2 wt. %;
from about 0.01 to about 1 wt. %; or
from about 0.025 to about 1 wt. %.

7. The method of claim 1, wherein an amount of the lactase enzyme in the mixture is:
from about 2 to about 1000 ppm;
from about 5 to about 500 ppm;
from about 2 to about 200 ppm; or
from about 3 to about 150 ppm.

8. The method of claim 1, further comprising before step (a), a step of heating the mixture from a temperature of less than or equal to about 10° C. to the peak temperature.

9. The method of claim 8, wherein the step of heating the mixture is performed in a time period in a range:
from about 5 sec to about 5 min;
from about 2 sec to about 2 min;
from about 5 sec to about 1 min;
from about 2 sec to about 3 min; or
from about 5 sec to about 30 sec.

10. The method of claim 1, further comprising between step (a) and step (b), a step of heating the dairy composition from the peak temperature to a temperature for heat treating in step (b).

11. The method of claim 1, wherein the step of heat treating comprises:
UHT sterilization at a temperature in a range from about 135° C. to about 145° C. for a time period in a range from about 1 to about 10 sec;
UHT sterilization at a temperature in a range from about 148° C. to about 165° C. for a time period in a range from 0 to about 1 sec, from about 0.05 to about 1 sec, or from about 0.05 to about 0.5 sec; or
pasteurizing at a temperature in a range from about 80° C. to about 95° C. for a time period in a range from about 2 to about 15 min.

12. The method of claim 1, wherein the step of heat treating comprises UHT sterilization conducted using indirect heating, UHT sterilization conducted using direct steam injection, or UHT sterilization conducted using direct steam infusion.

13. The method of claim 1, wherein the method is performed continuously.

14. The method of claim 1, wherein the dairy product or the dairy composition is whole milk, low-fat milk, skim milk, buttermilk, flavored milk, low lactose milk, high protein milk, lactose-free milk, ultra-filtered milk, micro-filtered milk, concentrated milk, evaporated milk, or high protein, high calcium, and reduced sugar milk.

15. The method of claim 1, wherein the dairy product or the dairy composition comprises a UF permeate fraction, a UF retentate fraction, a NF permeate fraction, a NF retentate fraction, a RO permeate fraction, a RO retentate fraction, a fat-rich fraction, or any combination thereof.

16. The method of claim 1, wherein the dairy product or the dairy composition has:
a fat content of from about 0.05 to about 10 wt. %, or a fat content of from about 0.1 to about 5 wt. %; or
a protein content of from about 1 to about 15 wt. %, a protein content of from about 3 to about 10 wt. %, a protein content of from about 2 to about 8 wt. %, or a protein content of from about 3 to about 6 wt. %; or
a mineral content of from about 0.5 to about 2 wt. %, a mineral content of from about 0.5 to about 1.5 wt. %, or a mineral content of from about 0.5 to about 1 wt. %; or
a solids content of from about 5 to about 50 wt. %, a solids content of from about 6 to about 35 wt. %, or a solids content of from about 8 to about 16 wt. %; or
any combination thereof.

17. The method of claim 1, wherein the dairy product or the dairy composition contains:
less than or equal to about 0.5 wt. % fat, from about 2 to about 15 wt. % protein, and from about 0.5 to about 2 wt. % minerals;
from about 0.5 to about 1.5 wt. % fat, from about 2 to about 15 wt. % protein, and from about 0.5 to about 2 wt. % minerals;
from about 1.5 to about 2.5 wt. % fat, from about 2 to about 15 wt. % protein, and from about 0.5 to about 2 wt. % minerals; or
from about 2.5 to about 5 wt. % fat, from about 2 to about 15 wt. % protein, and from about 0.5 to about 2 wt. % minerals.

18-23. (canceled)

24. The method of claim 1, wherein:
the method further comprises a step of packaging the dairy composition in a container;
the dairy product or the dairy composition further comprises an ingredient; and
the lactase enzyme is a beta-galactosidase.

25. The method of claim 1, wherein the lactase enzyme is stable at the peak temperature and/or not deactivated at the peak temperature.

26. The method of claim 1, wherein the lactase enzyme is deactivated at a temperature over 80° C.
